(19) United States
(12) Patent Application Publication
(10) Pub. No.: US 2009/0238647 A1
(43) Pub. Date: Sep. 24, 2009

(54) METHOD FOR COUPLING SEISMOMETERS AND SEISMIC SOURCES TO THE OCEAN FLOOR

(75) Inventors: Neil Ernest Delfino, Kingwood, TX (US); Joshua Ronen, Orinda, CA (US); Cung Khac Vu, Houston, TX (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/360,697

(22) Filed: Jan. 27, 2009

Related U.S. Application Data
(60) Provisional application No. 61/028,808, filed on Feb. 14, 2008.

(51) Int. Cl. F16L 1/12; G01V 1/24

(52) U.S. Cl. 405/172; 702/14

(57) ABSTRACT

The present invention is directed to methods for coupling seismometers and seismic sources to the ocean floor that results in improved seismic data quality and repeatability for reservoir management and seismic monitoring activities. Piles are configured with a coupling device and permanently installed on the ocean floor. The seismometers or seismic sources are acoustically coupled to the piles on the ocean floor via the coupling device. The pile, seismometer and seismic source may be surface treated with a material that releases divalent cations to enhance both the acoustic coupling and the load holding capacity of the pile. The pile is permanently imbedded into the seabed while the expensive and high-maintenance seismometers and seismic sources are redeployed on the piles as needed.

This application claims priority to U.S. Provisional Patent Application 61/028,808 filed Feb. 14, 2007, the contents of which are hereby incorporated by reference in their entirety.

### FIELD OF THE INVENTION

This invention relates generally to a method for securing seismometers and sources to the ocean floor, and specifically to coupling ocean bottom seismometers to the ocean floor to record seismic data.

### BACKGROUND

The seismic industry has been using ocean bottom seismometers (OBS) since the early 1990s for seismic monitoring of the subsurface. In addition to the higher cost of an OBS method compared to streamer methods, there are at least two obstacles to the commercial success of OBS methods: data quality due to coupling the OBS to the ocean floor and repeatability.

OBS data quality varies depending on both the design of the OBS and the ocean floor or seabed surface conditions. Data quality suffers the most in soft seabeds due to the poor coupling of the OBS to the ocean floor. Conventional practice couples seismometers directly on the seabed, on mats or pedestals which sit directly on the seabed, planted on rods or skirts which penetrate the seabed, or trenched into the seabed. Under these methods, the seismometers often have undesirable resonance and seafloor decoupling characteristics that induce certain noises. The most notable is a noise that appears as cross feed on the OBS sensor component which records vertical motion, particularly in very soft sediments.

Another problem in using OBS is repeatability. It is difficult and expensive to repeat the location of the OBS unless the OBS is installed permanently on the ocean floor. Permanently installed OBS has not been an attractive solution because of their high cost, high maintenance, and the likely under utilization of the seismometers.

Consequently, the coupling of the OBS to the seafloor is highly variable for each location and non-repeatable after each deployment. The resulting seismic images are less coherent and lack repeatability; two important characteristics for seismic data and time-lapse seismic data for field reservoir management purposes.

### SUMMARY OF THE INVENTION

The present invention is generally directed to a method for coupling seismometers on the ocean floor. The method includes configuring a pile and a seismometer for the ocean floor conditions, installing the pile into the ocean floor to a predetermined depth, and acoustically coupling the seismometer to the pile. In some embodiments, the pile is a suction pile; the pile is configured with a cam over clamp to acoustically couple the seismometer to the pile; an elastomeric ring may be placed between the seismometer and pile to improve the acoustic coupling; and the surface of the pile and the seismometer may be treated with an epoxy comprising embedded dolomite granules to improve the acoustic coupling and the load bearing capacity of the pile.

In other embodiments of the present invention the seismometer is an ocean bottom seismometer. The seismometer may record seismic data to monitor the conditions of the subsurface, the recorded seismic data may be active or passive seismic data. The seismometer may record seismic data autonomously or be networked to a surface facility with an ocean bottom cable to transfer the recorded seismic data to the surface facility.

In another embodiment, the present invention is directed to a method for coupling a seismic source on the ocean floor. The method includes configuring a pile and a seismic source for the ocean floor conditions, installing the pile into the ocean floor to a predetermined depth, and acoustically coupling the seismic source to the pile. In some embodiments, the pile is a suction pile; the pile is configured with a cam over clamp to acoustically couple the seismic source to the pile; an elastomeric ring may be placed between the seismic source and pile to improve the acoustic coupling; and the surface of the pile and the seismic source may be treated with ah epoxy comprising embedded dolomite granules to improve the acoustic coupling and the load bearing capacity of the pile.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a cross-section of an example suction pile device in accordance with an embodiment of the present invention;

FIG. 2 is a flowchart illustrating acts of a method in accordance with an embodiment of the present invention.

FIG. 3 A-D illustrate various embodiments of the present invention, showing different autonomous OBS configurations and locations.

FIG. 4 A-B illustrate various embodiments of the present invention, showing different wired or networked OBS configurations and locations.

FIG. 5 is a schematic representation of an embodiment of the present invention showing autonomous OBS on piles on the seafloor.

FIG. 6 is a schematic representation of an embodiment of the present invention showing networked OBS on piles on the seafloor.

### DETAILED DESCRIPTION OF THE INVENTION

In view of the foregoing, an economical method for coupling seismometers to the ocean floor that results in improved seismic data quality and repeatability would be extremely useful. This invention is directed to using permanently installed piles with seismometer coupling devices to securely couple seismometers to the ocean floor for repeatable reservoir surveillance, seismic monitoring and related activities. The pile is permanently imbedded into the seabed while the expensive and high-maintenance OBS are redeployed on the piles as needed.

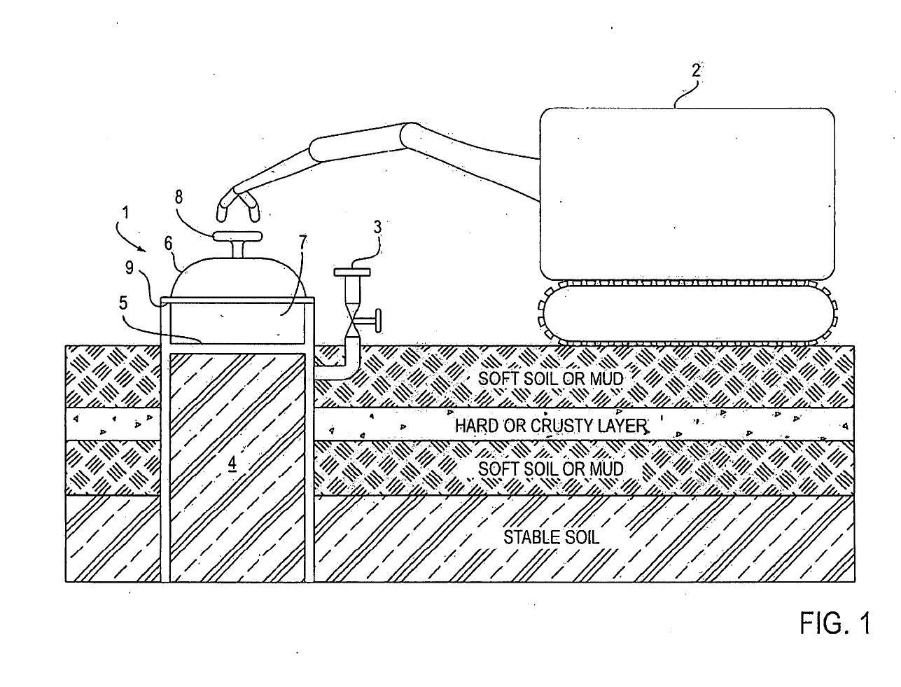

Referring to FIG. 1, agglomerated clay particles depositing on the ocean floor are not fully collapsed and contain upwards of 80% water by volume. Over time, more clay particles drop out and add weight to the sediment that dewaters the older sediments. This results in a density and soil strength gradient in the depositing soil that is normally increasing with depth of burial.

In the areas where hydrocarbon reservoirs are present in the very deep sediments, or in shallow sediments where accumulations of fermenting organic matter exist, there is another reaction occurring in the new sediments. The bacteria in the shallow sediments consume the methane that leaks from the reservoirs and/or emanates from the organic matter fermentation. The bacteria release carbon dioxide as a waste product. The carbon dioxide reacts with the calcium that is chelated to the clay platelets and forms calcium carbonate. This calcification of the soil occurs at approximately half to one meter into the ocean floor sediments and is shown in FIG. 1 as the hard or crusty layer. The resulting increase in soil strength is an anomaly on the soil strength gradient.

This soil strength anomaly is also an acoustic anomaly that interferes with seismometers placed directly oh the ocean floor. The sediment stack in the first one to two meters of the ocean floor acoustically acts like a sandwich of a rock between two sponges, shown in FIG. 1 as soft soil or mud. To eliminate the acoustic anomaly, the seismometer has to be coupled to the sediments stable soil below the soil strength anomaly. An elongated member, such as a pile that makes intimate contact with the stable soil sediments two to three meters below the ocean floor will allow the transmission of sound without acoustic interference from the anomaly. The circular diameter of an elongated member or pile would also reduce the acoustic interference. However, other shapes of piles can be used.

FIG. 1 illustrates an example of a suction pile device as the elongated member in accordance with an embodiment of the present invention. As will be appreciated, although a suction pile device is shown, other elongated members such as piles may be used and are considered to be within the scope of the present invention. Installing a suction pile 1 into the ocean floor is a subsea industry established process and includes but is not limited to using a diver or a remotely operated vehicle (“ROV”) 2 to suck the water from inside of the pile 1 through a suction mechanism 3. The pile 1 is deployed into the seabed by the ROV or diver until it reaches the desired depth, to provide strong and consistent coupling to the seafloor. The desired depth is controlled by the soil strength profile. The aim is to penetrate soft soils and reach stable soil. Furthermore, the large surface area of the pile 1 and the hollow interior 4 cause it to adhere well to the soil and create a system whose density matches the overall soil density. The large diameter, typically 1 meter, greatly reduces the likelihood of movement over time. The mounting base 5 provides an ideal surface for mounting seismometers 6, such as OBS, or seismic sources (not shown) of most any description.

The tops of the suction piles 1 have a receptacle 7 and cam over clamps 8 to mechanically hold the seismometers 6 or seismic sources. In other embodiments the clamping or coupling mechanism can be performed by other means such as screws, bolts, and various clamps, provided the seismometer 6 or source is acoustically coupled to the suction pile. If there is a need to dampen the acoustic coupling, due to the metal to metal contact between the pile 1 and the seismometer 6, elastomeric rings 9 may be optionally placed between the seismometer and the receptacle 7.

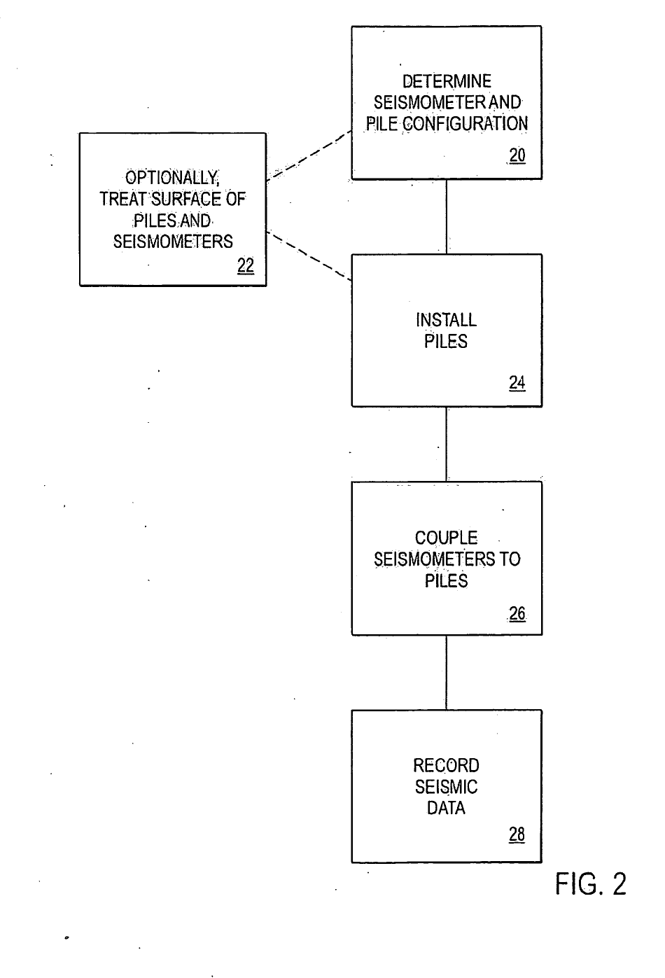

FIG. 2 is a flow diagram illustrating acts constituting an embodiment of a method in accordance with the present invention. The pile and seismometer are configured 20. The pile is configured for the ocean floor conditions and for the seismometer or source to be used. The length and diameter is adjusted according to local seabed conditions. The diameter and coupling device or clamping mechanism to be used on the pile are adjusted as required by the particular seismometer configuration. The clamping mechanism must be sufficient to provide acoustical coupling between the pile and the seismometer or source. The seismometer or source is configured for the pile to used, the clamping mechanism and the ocean floor conditions. In one embodiment of the present invention, the seismometer is an OBS. OBS usually have pressure sensors such as hydrophones, which measure the pressure and motion sensors such as acceleromerters or geophones to measure the motion of the seabed. OBS can have more sensors, putting them in different locations or using sensors set with different gain levels, or less sensors, recording only the pressure and the vertical motion. Some OBS have their hydrophone detached and floating in the water. What is common to all OBS is that pressure sensors such as hydrophones usually have less coupling problems than the motion sensors because the coupling to the water is less problematic than the coupling to the seabed. There are two reasons for recording both the pressure and the motion. One reason is that the direction of the waves can be detected from the combination of the pressure and the motion data and then use it to separate primaries from multiples. The other reason is that there are two types of waves, primary/pressure (P) waves and secondary/shear (S) waves. Given good data geophysicists can use both types of waves to confirm and complement the information about the structure, the lithology, the fluids, and the fractures of the subsurface reservoirs and drilling hazards.

In particular embodiments the pile and seismometer configuration may include optionally treating the surface 22 to improve the coupling to the seafloor. Ocean floor clay soils have a wide range of porosities and water contents. By chemically dewatering the clays, the acoustic properties of the soils can be controlled. The addition of divalent cations to soil will effectively dewater and consolidate the clays. Coating the surfaces of the piles, sources and seismometers where they will be in contact with the ocean soil, with a material that releases divalent cations over time will bond the equipment to the soil. This coating can be used for node type seismometers and the sensor pads for ocean bottom cable seismic arrays. The divalent cation coating will enhance both the acoustic coupling and the load holding capacity of the pile.

Source materials for divalent cations can include bare steel, epoxy coatings, ion exchange resin and calcium and magnesium containing minerals. Magnesium and calcium minerals have been used in other industries to dewater and stabilize clay soils. In the construction of roads over clay soils, it is a common practice to “lime” the soil with calcium hydroxide before attempting to compact the road base. Diffusion of calcium ions from a plaster of Paris mold is how a dispersed clay mixture known as slip is transformed into an even wall thickness ceramic object that can range from a vase to a toilet. Magnesium sulfate (Epsom salts) is used by farmers to stabilize the clays in their soil and improve water drainage. Epsom salts have also been used to temporarily settle the clay particles that are dispersed from the ocean floor by subsea equipment installation activity. In some embodiments of the present invention the coating is an epoxy with embedded dolomite granules, a calcium magnesium carbonate mineral. In areas where the ocean floor sediments are not clay rich, anionic ion exchange resin can be substituted for the dolomite particles. The ion exchange resin provides multi-cationic sites that are equivalent to divalent cations provided by the dolomite.

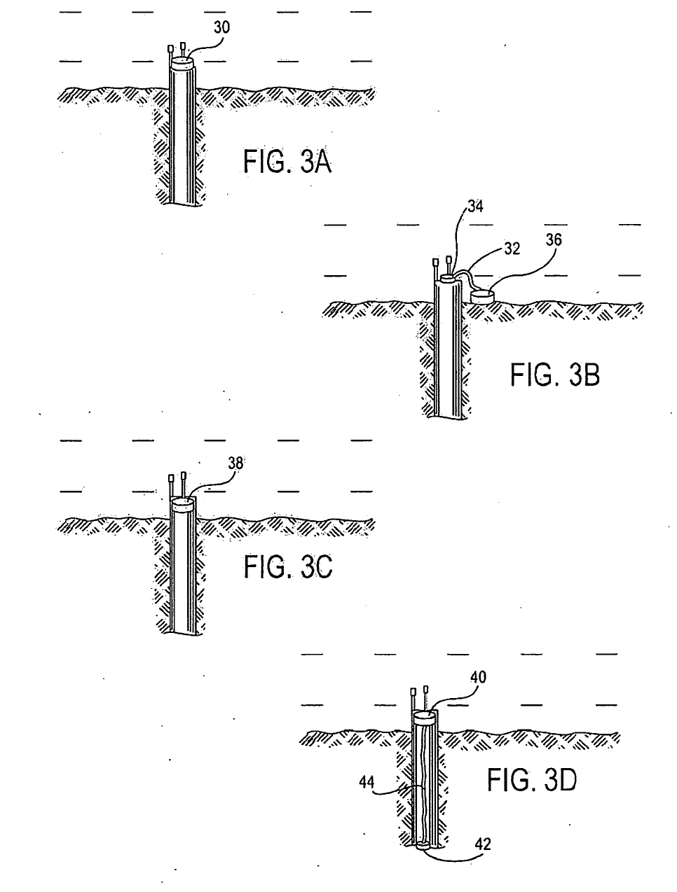

The pile is installed into the ocean floor 24 to a predetermined depth and the seismometer or source is coupled to the pile 26. The seismometer or source may be coupled to the piles at the surface before they are deployed or subsea using a diver, ROV or other technique known in the industry. Pile deployed seismometers or sources allow the location of each seismometer or source relative to the reservoir to be known for every collection of data. The seismometers can be autonomous, self contained, and in a variety of configurations as shown in FIG. 3A-D. FIG. 3A shows an autonomous OBS node 30 coupled to the top of a pile; FIG. 3B shows an autonomous OBS node 36 near the pile with an external sensor 34 coupled to the top of the pile and connected to the node 36 with a take out 32; FIG. 3C shows an autonomous OBS node 38 coupled inside the pile; and FIG. 3D shows an autonomous OBS node 40 coupled inside the pile connected to a sensor 42 at the bottom of the pile and connected to the node 40 with a take out 44.

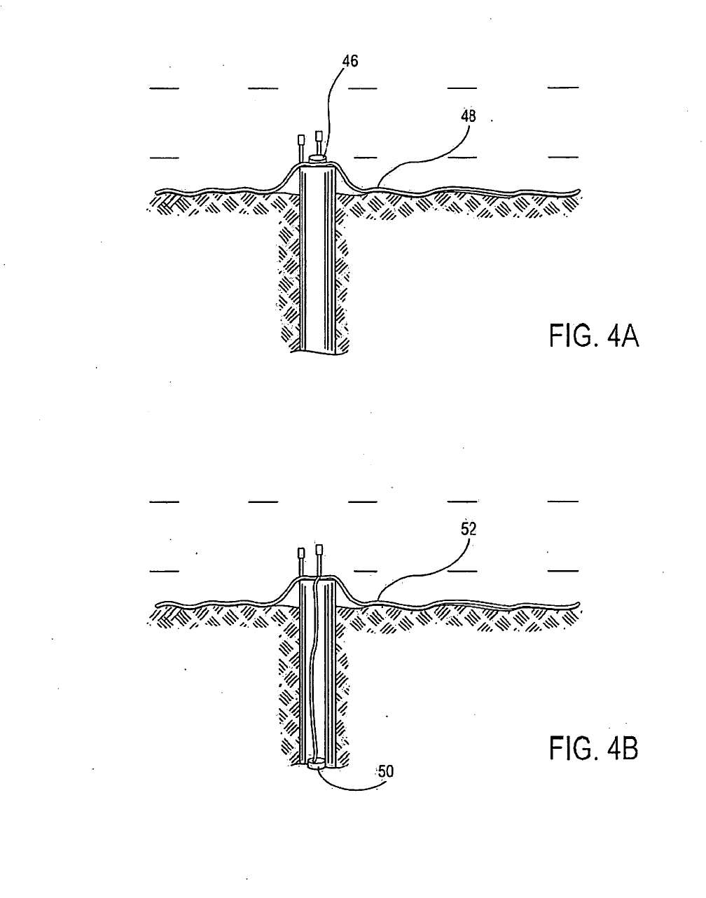

The seismometers can also be wired or networked together in a variety of configurations as shown in FIG. 4A-B, using any technique known in the industry such as by wire or fiber optic cables. FIG. 4A shows an OBS 46 coupled to the top of the pile wired with an ocean bottom cable 48; and FIG. 4B shows an OBS 50 at the bottom of the pile wired with an ocean bottom cable 52. It should be understood that the embodiments described in FIGS. 3A-D and 4A-B are not meant to be limiting. The present invention can include all manner of OBS that can be acoustically coupled to a pile.

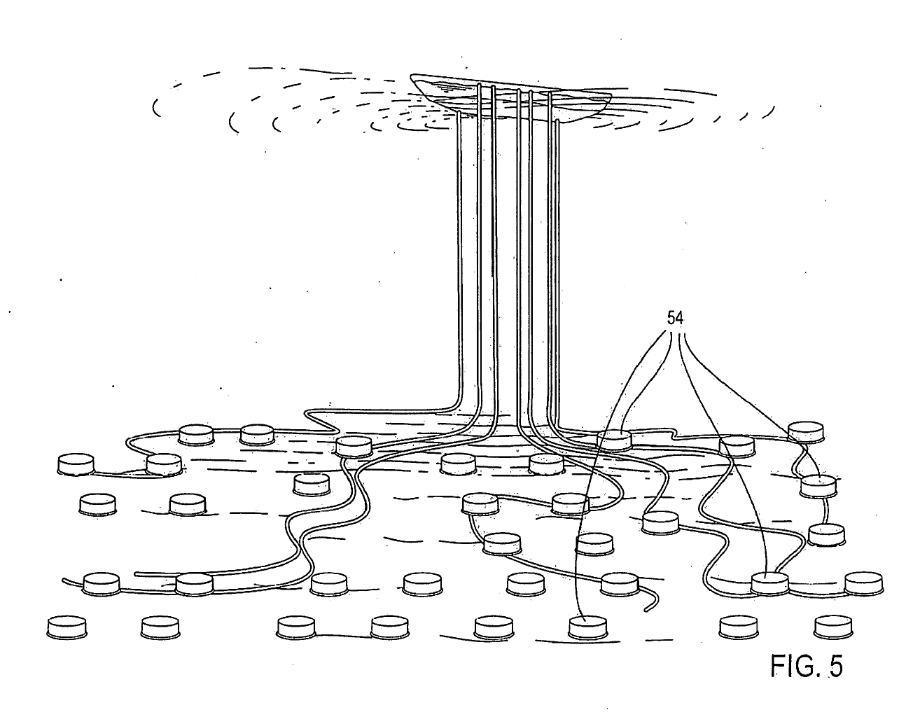

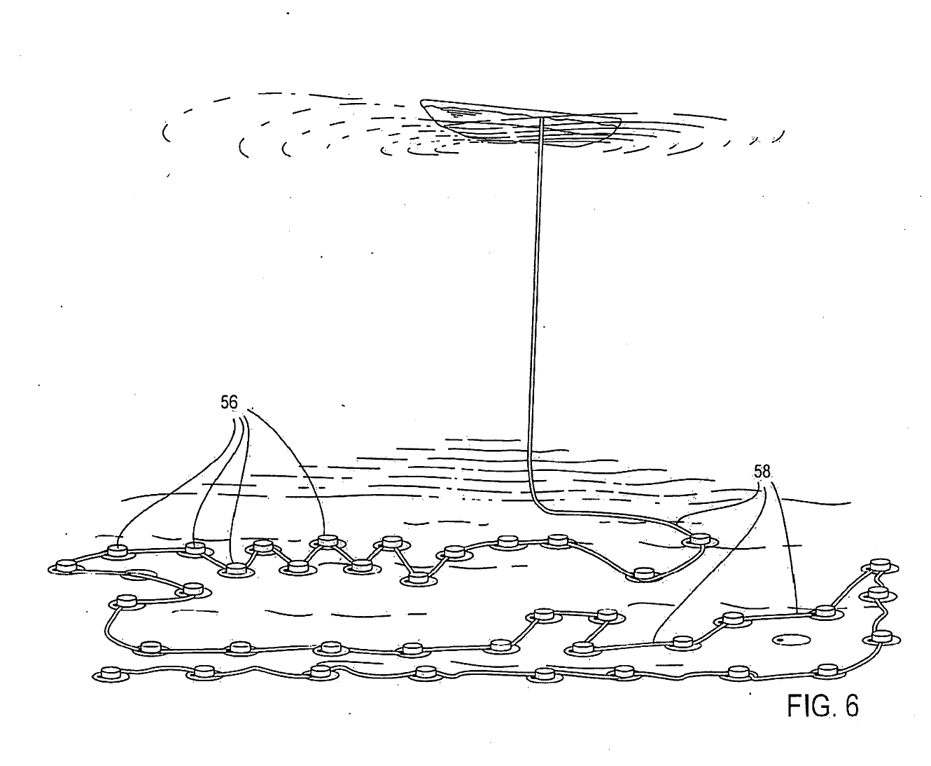

Referring back to FIG. 2, the seismometers record the active and passive seismic data and the seismic data is monitored 28. The resulting seismic data are free of cross feed and other system noise due poor coupling of the OBS to the ocean floor. Recorded data is removed from autonomous seismometers using an ROV or diver and recoupled to the suction pile after the data has been removed at the surface. Wired seismometers can transfer the recorded data electrically or acoustically to the surface. FIG. 5 is a schematic representation of an embodiment of the present invention showing autonomous OBS nodes 54 on piles on the seafloor while FIG. 6 is a schematic representation of an embodiment of the present invention showing OBS nodes 56 on piles on the seafloor wired or networked using a fiber optic or electrical cable 58. Active seismic applications rely on seismic sources which are typically air guns, but may be any other seismic source in the water, in borehole, or on the seabed, including seismic sources that may be coupled to the seabed using piles. In addition to the applications associated with recording active seismic, OBS can be used for passive seismic applications. These include frac monitoring, usage of drilling and completion activity as seismic sources, usage of shipping noise as seismic sources, spectral characterization using ambient noise, earthquake and seabed slide monitoring, and monitoring of biological sound.

The reservoir management applications of acoustically coupled seismometers or seismic sources to piles are therefore all the geophysical applications of the ocean bottom methods including: (i) using seabed motion sensors together with hydrophone data to separate down-going and up-going waves at the seabed for the purpose of multiple attenuation and imaging with multiples; (ii) to achieve wide azimuth coverage for the purpose of illumination and multiple attenuation; (iii) to record both pressure and shear waves to improve lithological and fracture characterization over what can be achieved with surface towed streamer data; (iv) for passive seismic recording of microseismic events induced by development and production such as hydrofracturing and subsidence; (v) for passive seismic recording of waves generated by natural and cultural sources such as swell and shipping noise; (vi) to record data from active seismic sources near the sea surface; (vii) to deploy active ocean bottom seismic sources; and (viii) to monitor reservoir fluids and pressure, identify flow barriers, optimize production methods, and find bypassed oil.

The placement of a pile into the ocean floor establishes a surveyable location relative to the reservoir and the world. Since the pile is permanent until it may have to be removed at the end of the field life, it remains a landmark. Once the first pile is installed for an area, all other piles can be surveyed in reference to it. Patterns of seismometer locations (suction pile locations), or source locations can be trialed to determine if there is merit to optimizing the number and relative locations to the reservoir shapes.

Removing a suction pile from the ocean floor is a subsea industry established process. The process involves pumping water in through the top of the pile and breaking the adhesion of the clay to the inside and outside surfaces of the pile. Removal can be done when necessary and the suction pile reused.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed:

1. A method for coupling seismometers on the ocean floor, the method comprising:
configuring a pile and a seismometer for the ocean floor conditions;
installing the pile into the ocean floor to a predetermined depth; and
acoustically coupling the seismometer to the pile.

2. The method of claim 1, wherein the pile is a suction pile.

3. The method of claim 2, wherein an elastomeric ring is placed between the seismometer and suction pile to improve the acoustic coupling.

4. The method of claim 1, wherein the pile is configured with a cam over clamp to acoustically couple the seismometer to the pile.

5. The method of claim 1, wherein the surface of the pile and the seismometer are treated with an epoxy comprising embedded dolomite granules to improve the acoustic coupling and the load bearing capacity of the pile.

6. The method of claim 1, wherein the seismometer records seismic data to monitor the conditions of the subsurface.

7. The method of claim 6, wherein the seismometer records active seismic data.

8. The method of claim 6, wherein the seismometer records passive seismic data.

9. The method of claim 1, wherein the seismometer is an ocean bottom seismometer.

10. The method of claim 1, wherein the seismometer records seismic data autonomously.

11. The method of claim 1, wherein the seismometer is networked to a surface facility with an ocean bottom cable to transfer the recorded seismic data to the surface facility.

12. A method for coupling a seismic source on the ocean floor, the method comprising:
configuring a pile and a seismic source for the ocean floor conditions;
installing the pile into the ocean floor to a predetermined depth; and
acoustically coupling the seismic source to the pile.

13. The method of claim 12, wherein the pile is a suction pile.

14. The method of claim 13, wherein an elastomeric ring is placed between the seismic source and suction pile to improve the acoustic coupling.

15. The method of claim 12, wherein the pile is configured with a cam over clamp to acoustically couple the seismic source to the pile.

16. The method of claim 12, wherein the surface of the pile and the seismic source are treated with an epoxy comprising embedded dolomite granules to improve the acoustic coupling and the load bearing capacity of the pile.

17. A system for recording seismic data, the system comprising:
a suction pile installed into the ocean floor;
an ocean bottom seismometer acoustically coupled to the suction pile with a cam over clamp, wherein the surface of the suction pile and the ocean bottom seismometer are treated with an epoxy and an elastomeric ring is placed between the ocean bottom seismometer and the suction pile; and
recording active and passive seismic data with the ocean bottom seismometer to monitor the conditions of the subsurface.
